(19) United States
(12) Patent Application Publication
(10) Pub. No.: US 2004/0136298 A1
(43) Pub. Date: Jul. 15, 2004

(54) Disk device and disk method

(75) Inventor: Toshio Ichikawa, Fussa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/721,799

(22) Filed: Nov. 26, 2003

(30) Foreign Application Priority Data
Nov. 29, 2002 (JP) 2002-348706

(51) Int. Cl. G11B 7/125

(52) U.S. Cl. 369/53.26; 369/53.3

(57) ABSTRACT

There is provided a disk device has a controller which determines a linear velocity V_{L} of a disk, a laser output determination circuit which determines a read laser output P_{R} of a photodiode according to this linear velocity and causing the photodiode to emit a laser light on the basis of a control signal C corresponding to the determined read laser output, and a sampling circuit which detects the emitted laser light by a front monitor and makes the control signal of the laser output determination circuit appropriate according to a sampling result obtained by performing the detection several times, wherein, even when a recording processing is performed at high velocity, sampling control of the read laser output can be securely performed.

### CROSS-REFERENCE TO RELATED APPLICATIONS

This application is based upon and claims the benefit of priority from the prior Japanese Patent Application No. 2002-348706 filed Nov. 29, 2002, the entire contents of which are incorporated herein by reference.

### BACKGROUND OF THE INVENTION

1. Field of the Invention

The present invention relates to a disk device, particularly to a disk device and a disk processing method for performing servo sampling control of a read laser output P_{R}.

2. Description of the Related Art

In recent years, a recording optical disk, that is CD-R (Compact Disk-Recording), DVD-R (Digital Versatile Disk-Recording), DVD-RW (Digital Versatile Disk-Rewritable), DVD-RAM, and the like have been spread and made popular, and a recording/reproducing technique therefor is accordingly desired to more improve.

A conventional technique of such an optical disk device is configured such that power of light is separately self-adjusted in a read control system and in a write control system and self-adjustment is performed when a difference therebetween exceeds a predetermined value to obtain a proper power output (refer to patent reference 1, for example). In such a conventional technique, in a recording optical disk such as CD-R, DVD-R, or the like, a servo sampling timing at the time of recording is sampled after a signal level reaches a read signal level after a write signal is changed to LOW. When the recording velocity is low, even a value with a low read level sufficiently affords to have a time for performing sampling processing at the read level so that the sampling control can be performed for both a write power output and a read power output.

However, in the recording disk such as CD-R, DVD-R, or the like, since, as the recording velocity is made faster, an output pulse cycle of a photo detector (PD: Photo Detector) is made shorter, the servo sampling enable period at the time of recording does not afford.

In other words, since the recording power is increased and the output pulse cycle is made shorter by speeding up, when sampling is performed at the same read laser output P_{R} as at the lower velocity, a sampling enable period T where the sampling of the read power laser output P_{R} can be performed is made remarkably short. Thus, there is a problem that the sampling control fails, the control runs away, and an appropriate read laser output P_{R} cannot be obtained. At the same time, there is problem that an appropriate RF signal cannot be obtained due to this control failure of the read laser output P_{R} so that a focus servo or a tracking servo is made unstable.

### BRIEF SUMMARY OF THE INVENTION

One embodiment according to the present invention provides a disk device comprising a controller for determining a linear velocity at the time of rotating a disk on the basis of given operation information and control information read from the disk, a laser output determination circuit for determining a read laser output of a photodiode according to the linear velocity determined by the controller, and causing the photodiode to emit a laser light on the basis of a control signal corresponding to the determined read laser output, and a sampling circuit for detecting a laser light emitted by the photodiode by a monitor, and making the control signal of the laser output determination circuit appropriate according to a sampling result obtained by performing the detection several times.

### BRIEF DESCRIPTION OF THE SEVERAL VIEWS OF THE DRAWING

FIG. 1 is a block diagram showing one example of a configuration of an optical disk device according to the present invention;

FIG. 2 is a block diagram showing a configuration of one example of a pickup of the optical disk device according to the present invention;

FIG. 3 is a timing chart showing one example of a relationship between a laser detection signal, a read laser output P_{R}, and a sampling enable period T in the optical disk device according to the present invention;

FIG. 4 is a flow chart showing one example of an operation of laser output control according to the present invention; and

FIG. 5 is a flow chart showing another example of the operation of the laser output control according to the present invention.

### DETAILED DESCRIPTION OF THE INVENTION

Hereinafter, one embodiment of an optical disk device according to the present invention will be described in detail with reference to the drawings.

<Optical Disk Device According to the Present Invention>

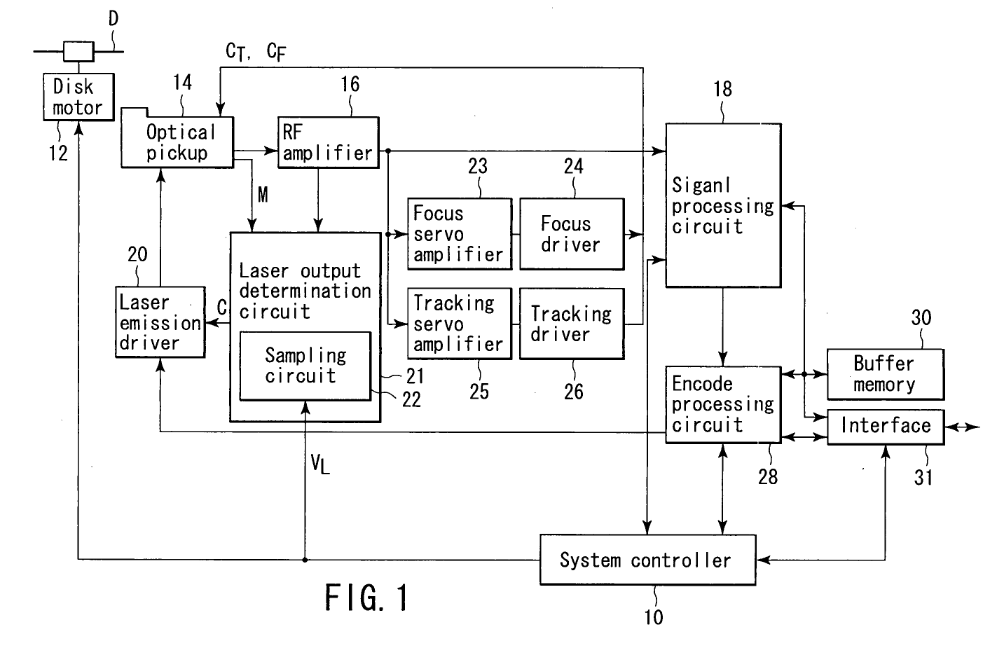

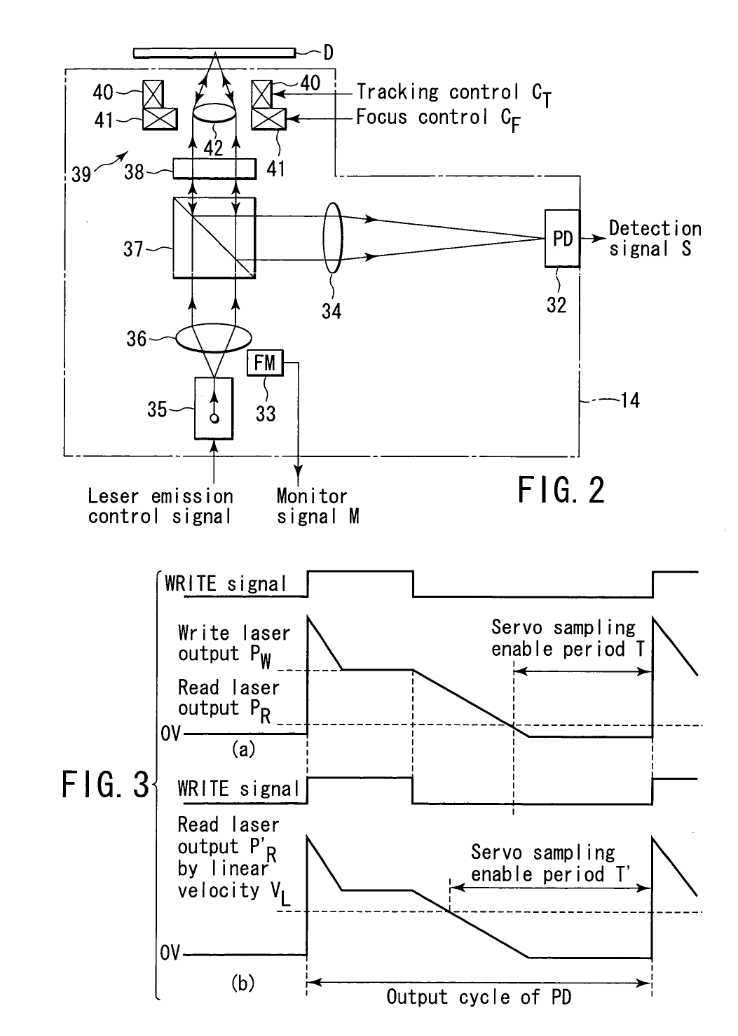

FIG. 1 is a block diagram showing one example of a configuration of the optical disk device according to the present invention, and FIG. 2 is a block diagram showing a configuration of one example of a pickup.

(Configuration)

In FIG. 1, the optical disk device according to the present invention has a disk motor 12 for holding an optical disk D and rotating the same a predetermined velocity, an optical pickup 14 for emitting a light beam on the optical disk D and detecting a reflected light, a RF amplifier 16 to which a detected signal is supplied for generating a RF signal and a servo signal, a signal processing circuit 18 to which the RF signal is supplied, and a laser output determination circuit 21. The laser output determination circuit 21 has a sampling circuit 22 which does sampling the RF signal and determines appropriate laser output in the reading and writing periods. Further, the optical disk device has an interface 31 for transmitting/receiving data with the outside and a buffer memory 30 connected to the interface 31 for temporarily storing given data or reproduced data read by the optical pickup 14.

Further, the optical disk device has an encode processing circuit 28 connected to the buffer memory 30 and the interface 31 for encoding given data, and a laser emission driver 20 to which an output encoded by the encode processing circuit 28 is supplied. The laser emission driver 20 is controlled in an output thereof by a control signal C from the laser output determination circuit 21 connected to a system controller 10 which governs the entire system operations, and generates a laser light based on the RF signal supplied from the RF amplifier 16 by the optical pickup 14. In addition, the system controller 10 is connected to the above respective sections via a data bus, and controls the operations thereof.

Further, the optical disk device has a focus servo amplifier 23 and a focus driver 24 for performing focus control in the optical pickup 14 in reception of a focus error signal which is a servo signal generated in this RF amplifier 16, and further a tracking servo amplifier 25 and a tracking driver 26 for performing tracking control in the optical pickup 14 in reception of a tracking error signal which is a servo signal generated in this RF amplifier 16.

Furthermore, the optical pickup 14 of the optical disk device according to the present invention has an actuator 39 for holding an objective lens 42 as shown in FIG. 2, and the actuator 39 is provided with an actuator drive coil 40 in a tracking direction and an actuator drive coil 41 in a focus direction. Here, a tracking control signal C_{T} and a focus control signal C_{F} are supplied from the tracking driver 23 and the focus driver 24 described above, respectively, so that servo control is enabled.

The optical device 14 is directed for performing both light emission and light reception by the working of a beam splitter 37 and the like. To emit a laser light from a photodiode 35 corresponding to a control signal of the laser emission driver 20, the emission passes through the beam splitter 37 via a lens 36 and is condensed by the objective lens 42 via a ¼ wavelength plate 38 and the like to be emitted on a predetermined area of the optical disk D. Further, a reflected light from the optical disk D is expanded by the objective lens 42 and is separated to a condenser lens 34 side from the beam splitter 37, and is further supplied to a photo detector 32. The photo detector 32 supplies a detection signal S, a tracking error signal and a focus error signal are supplied to the tracking servo amplifier 21 and the focus servo amplifier 23 via the RF amplifier 16, respectively, and further the detection signal S for generating a reproduction signal is supplied to the signal processing circuit 18.

(Basic Operation)

In the optical disk device having such a configuration, a reproducing processing of the optical disk is performed as follows. In other words, the optical disk D rotated at a predetermined velocity by the disk motor 12 generates a laser light according to the laser emission driver 20 set in the laser output determination circuit 21, a reflected light thereof is detected by the optical pickup 14, and a detection signal based thereon is output under control of the system controller 10. This detection signal is supplied to the RF amplifier 16, and the RF signal output therefrom is supplied to the signal processing circuit 18 and the laser output determination circuit 21, and the focus error signal and the tracking error signal which are servo signals generated in the RF amplifier 16 are supplied to the focus servo amplifier 23 and the tracking servo amplifier 25, respectively. The RF signal is decoded in the signal processing circuit 18, and the decoded signal is temporarily stored in the buffer memory 30 or is output to the outside via the interface 31 as it is. Further, the system controller 10 generates a control signal for controlling rotation of the disk motor 12 to control the rotation of the disk motor 12.

Furthermore, in the optical disk device having such a configuration, a recording processing of the optical disk is performed as follows. In other words, for example, data supplied via the interface 31 is temporarily stored in the buffer memory 30 and is then supplied to the encode processing circuit 28 to be encoded and output under control of the system controller 10. A driver output of the laser emission driver 20 is supplied to the optical pickup 14 according to this encoding output and the output of the laser output determination circuit 21. A laser light corresponding to this driver output is emitted from the mounted photodiode 35 in the optical pickup 14 and is emitted in a storage area in the optical disk D which is rotated at a predetermined velocity by the disk motor 12 so that the recording processing is performed.

<Sampling Control of Read Laser Output in Optical Disk Device According to the Present Invention>

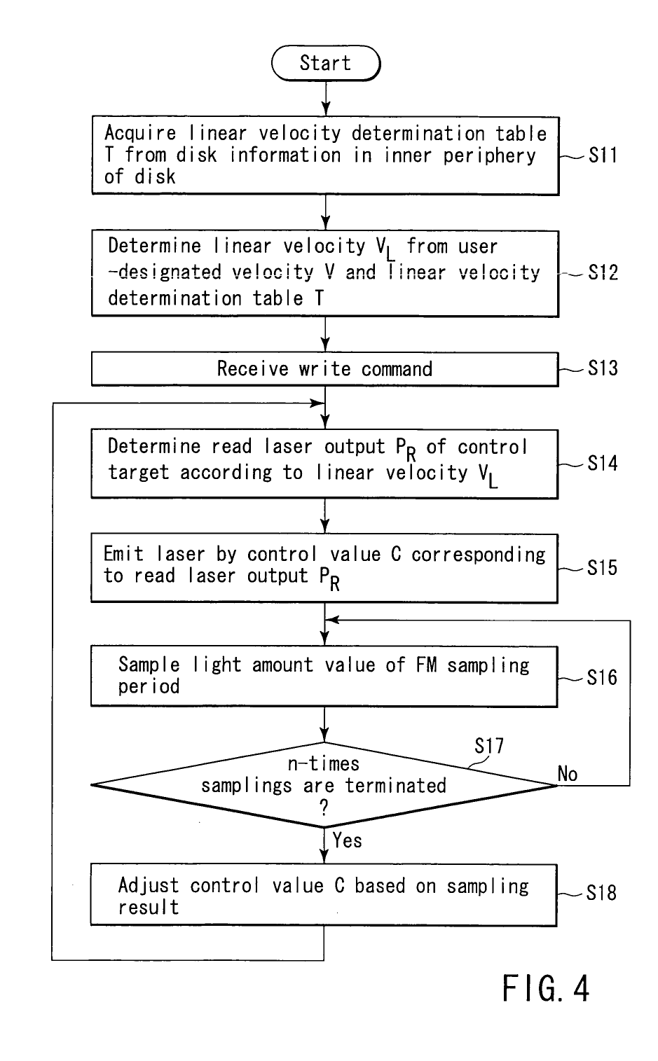

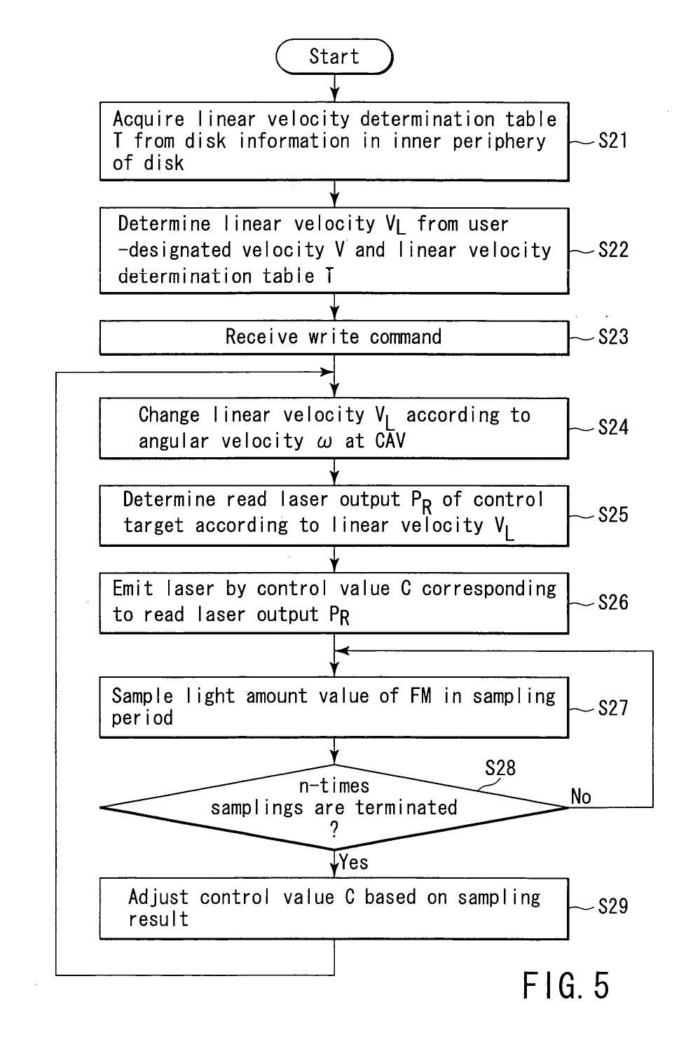

In such an optical disk device, sampling control of a write laser output P_{W} for a recording processing and a read laser output P_{R} for a reproducing processing is particularly performed, and the sampling control of a read laser output corresponding to a linear velocity V_{L} as a characteristic of the present invention will be below described in detail with reference to the drawings. FIG. 3 is a timing chart showing one example of a relationship between a laser detection signal, a read laser output PR, and a sampling enable period T in the optical disk device according to the present invention, FIG. 4 is a flow chart showing one example of an operation at the time of the CLV control of laser output control according to the present invention, and FIG. 5 is a flow chart showing one example of an operation at the time of the CAV control.

(Sampling Control Operation at the Time of CLV Control)

First of all, a sampling operation at the time of the CLV control in the optical disk device according to the present invention will be described. A laser output of the photodiode 35 is determined in a recording operation (or reproducing operation) of the optical disk device. This laser output includes a write laser output P_{W} and a read laser output P_{R}, and both has to be determined for performing the recording operation, and at least the read laser output P_{R} has to be determined for the reproducing operation.

In the timing chart shown in (a) of FIG. 3, the output of the photodiode 35 is shown, and is transited from a peak level through a level of the write laser output P_{W} to a level of the read laser output P_{R} to terminate the cycle according to an output cycle of the photo detector 32. A similar signal change is repeated again in the next cycle.

The write laser output P_{W} and the read laser output P_{R} read control information in the inner periphery side of the optical disk, and further the respective optimal values are determined by the laser output determination circuit 21 according to a recording velocity and the like set from a user's operation panel. Thereafter, sampling is performed for the RF signal n times for output cycle of the photodiode by the sampling circuit 22, and a determination is made as to whether or not the write laser output P_{W} and the read laser output P_{R} having the target values have been obtained. The control signal C from the laser output determination circuit 21 is properly corrected to an appropriate value according to a sampling result so that the servo sampling control is performed. Thereby, for example, variation of performance of the photodiode 35 is absorbed so that the write laser output P_{W} and the read laser output P_{R} to be targeted can be stably obtained.

However, as a recording velocity of an optical disk has been increased in recent years, there has been arisen a problem that a period T of this servo sampling cannot be sufficiently secured. In other words, (a) of FIG. 3 is a timing chart indicating a laser output during one cycle of the recording processing when the write laser output P_{W} corresponding to the linear velocity of the present invention is not given. Here in one cycle of (a) of FIG. 3, a value of the laser output is gradually made smaller after a writing processing by the write laser output P_{W} and reaches a value of the read laser output P_{R}, and then the servo sampling is enabled. The servo sampling can be performed only after the value of the laser output is lowered to the value of the read laser output P_{R}. Therefore, it is desirable that the laser output reaches the read laser output P_{R} from the write laser output P_{W} as early as possible and the servo sampling enable period T is secure long. The servo sampling enable period T capable of this servo sampling is indicated in (a) of FIG. 3, and it is required that this period is secure long in order to stably perform the servo sampling.

Here, since a recording velocity of an optical disk has been increased as a recent trend, it is required that writing is rapidly performed by a strong laser in a short time, so that a required value of the write laser output P_{W} has also become higher. Further, an output cycle of PD also tends to shorten. Since a potential of the laser output also has inertia, it is difficult to instantaneously change the potential. The laser output requires a constant time for reaching a low read laser output P_{R} from a high value of the write laser output P_{W}. Therefore, when a high write laser output P_{W} or reduction in the output cycle of PD is demanded, a margin in the servo sampling enable period T is made smaller so that the sufficiently long servo sampling enable period T cannot be secured as shown in (a) of FIG. 3.

As a result, when the servo sampling enable period T is insufficient, the servo sampling of the read laser output P_{R} fails and the control runs away so that the read laser output P_{R} cannot take an appropriate value.

In this case, the value of the RF signal also becomes unstable, and the focus servo control and the tracking servo control using the RF signal also become unstable at the same time so that it is difficult to accurately perform recording/reproducing processings.

According to the present invention, as shown in the timing chart in (b) of FIG. 3, the value of the read laser output P_{R} is not simply determined only by management information of the optical disk and operation information such as the user-desired recording velocity unlike conventionally, and is changed to a larger value according to the linear velocity V_{L} of the optical disk D determined based thereon. Thereby, a servo sampling enable period T′ can be secured long as shown in (b) of FIG. 3. In other words, when the value of the read laser output P_{R} is made larger, a longer time until a level of the write laser output P_{W} is lowered to a level of the read laser output P_{R} is not required than conventionally so that the RF signal relatively early reaches a level where the servo sampling is possible (level of the read laser output PR). Thus, as can be seen from a comparison between the servo sampling enable period T in (a) of FIG. 3 and the servo sampling enable period T′ in (b) of FIG. 3, the servo sampling enable period T′ can be secured longer. Thereby, even when the recording velocity is made faster, the sampling control of the read laser output P_{R} can be stably performed.

Further, a processing for changing this read laser output P_{R} to a larger value according to the linear velocity V_{L} of the optical disk D is not performed only by the recording processing, and can be performed at the time of the reproducing processing. Therefore, similarly in the reproducing processing, even when the rotation frequency of the optical disk is increased, the servo sampling control of the read laser output PR can be securely performed so that the stable read laser output P_{R} can be obtained, thereby performing the reproducing processing with high operation reliability.

Next, the sampling control of the read laser output P_{R} according to the present invention when the optical disk is rotated by the CLV control will be described along with the flow chart in FIG. 4. When the optical disk D is mounted, a linear velocity determination table T is acquired from control information in the inner periphery of the optical disk D (S11), and a linear velocity V_{L} is determined on the basis of at least a user-designated recording velocity V and the linear velocity determination table T (S12) under control of the system controller 10. Next, when a write command is received (S13), the read laser output P_{R} which is a control target is determined according to the magnitude of the linear velocity V_{L} supplied from the system controller 10 by the working of the laser output determination circuit 21 (S14).

Here, various methods can be employed as to which read laser output P_{R} is given to a value of the linear velocity V_{L}. One of the methods is directed for determining the read laser output P_{R} relative to the linear velocity V_{L} by the proportional function on the basis of a substantially constant proportional constant “a”. Another one is directed for setting one or more threshold values of the linear velocity V_{L} and stepwise changing the read laser output P_{R} according to these threshold values. Still another one is directed for previously providing a conversion table between the linear velocity V_{L} and the read laser output P_{R} and allocating the read laser output P_{R} optimal to each value of the linear velocity V_{L}.

As one example of a specific value, in the case of a 32-time velocity CD-R, the read laser output PR can be increased from 3 mW to 6 mW relative to the write laser output P_{W} of 50 mW. Further, there is a measurement result that the read laser output P_{R} can be increased to about ¼ of the write laser output P_{W}, so that the read laser output P_{R} can be changed to the optimal value in this range.

Next, the control signal C corresponding to this read laser output P_{R} is supplied to the laser emission driver 20 so that the laser emission control signal corresponding thereto is supplied from the laser emission driver 20 to the photodiode 35 and the laser is emitted on the optical disk D via the lens 36 and the like (S15). At this time, the detection result detected by a front monitor 33 provided in the vicinity of the photodiode 35 is sampled n times (S16, S17). The front monitor 33 is sensor, which senses directly the emission from the photodiode 35. When n-times samplings are terminated (S17), a value of the control signal C from the laser output determination circuit 21 is appropriately adjusted according to this sampling result so that the servo control is led to the initially set read laser output P_{R} (S18). Thereby, variation of the performance of the photodiode 35 is mainly absorbed so that the stable read laser output P_{R} is supplied.

Thereby, according to the optical disk device of the present invention, even when the optical disk is made faster in the recording or reproducing processing, a value to be set of the read laser output P_{R} is changed according to the linear velocity V_{L} of the optical disk so that the stable servo sampling of the read laser output P_{R} can be performed. Thus, since the stable RF detection value can be obtained, the stable servo control is simultaneously enabled even in the focus control or the tracking control based on the RF detection value.

(Sampling Control Operation at the time of CAV Control)

Next, a sampling operation at the time of the CAV control in the optical disk device according to the present invention will be described using a flow chart in FIG. 5. The CAV (Constant Angular Velocity) system is generally directed for controlling rotation velocity control of a disk motor at a constant angular velocity by the disk motor rotation velocity detection (FG pulse), wherein, when the disk where a data rate is recorded at a constant linear velocity is reproduced at a constant angular velocity, a reproducing rate thereof becomes higher as a track diameter becomes longer. Since the CAV rotation control depends on only the disk motor rotation velocity detection (FG pulse), it is advantageous to restrict variation in the rotation velocity.

Also in the CAV system, the sampling control of the read laser output P_{R} according to the present invention is possible by a substantially similar method. Particularly, in step S24, the linear velocity V_{L} at that time is specified so that the read laser output P_{R} corresponding to the linear velocity V_{L} is determined. Therefore, as the linear velocity V_{L} changes from the outer periphery to the inner periphery, the read laser output P_{R} is also changed.

In other words, when the optical disk D is mounted, the linear velocity determination table T is acquired from control information in the inner periphery of the optical disk (S21), and the linear velocity V_{L} is determined on the basis of at least a user-designated recording velocity V and the linear velocity determination table T (S22) under control of the system controller 10. Next, when a write command is received (S23), if the CAV control is performed, the linear velocity V_{L} at the point of time is obtained according to an angular velocity ω (S24). Then, the read laser output P_{R} which is a control target is determined according to the magnitude of the obtained linear velocity V_{L} by the working of the laser output determination circuit 21 (S25).

Next, when the control signal C corresponding to this read laser output P_{R} is supplied to the laser emission driver 20, a laser emission control signal corresponding thereto is supplied from the laser emission driver 20 to the photodiode 35 and a laser is emitted on the optical disk D via the lens 36 and the like (S26). At this time, the detection result detected by the front monitor 33 provided in the vicinity of the photodiode 35 is sampled n times (S27, S28). When n-times samplings are terminated (S28), a value of the control signal C from the laser output determination circuit 21 is appropriately adjusted according to this sampling result, and the servo control is led to the initially set read laser output PR (S29). Thereby, variation of the performance of the photodiode 35 is absorbed so that the stable read laser output P_{R} is supplied.

Thereafter, the processing returns to step S24, where the linear velocity V_{L} corresponding to the angular velocity co at this point of time is obtained, and then the processings after step S25 are repeated.

According to these procedures, even when the optical disk D is rotationally controlled by the CAV control, the control of the read laser output P_{R} can be stably performed similarly in the case of the CLV control. Therefore, even when writing or reading is performed at high velocity, the servo sampling control of the read laser output P_{R} does not run away unlike conventional device, so that it is possible to provide an optical disk device and an optical disk processing method capable of performing operation control with high reliability.

Those skilled in the art can realize the present invention by various embodiments described above, and further can easily invent various modifications of these embodiment, and can apply them to various embodiments without inventive ability. Therefore, the present invention covers a wide range which is not contradictory to the disclosed principle and novel characteristics, and is not limited to the above embodiments.

For example, as far as the linear velocity V_{L} is specified, the present invention can be applied to an optical disk device using other control system such as ZCLV (Zone Constant Linear Velocity) other than the above systems.

As described above in detail, according to the present invention, even when a recording processing and a reproducing processing are performed at high velocity, a value of the read laser output P_{R} is increased according to the linear velocity V_{L} so that the sampling enable period can be secure. Therefore, it is possible to provide an optical disk device and an optical disk processing method capable of performing secure control of the read laser output P_{R} without runaway of the servo sampling control of the read laser output and stably operating focus control/tracking control on the basis thereof.

What is claimed is:

1. A disk device comprising:
a controller which determines a linear velocity at the time of rotating a disk on the basis of given operation information and control information read from the disk;
a laser output determination circuit which determines a read laser output of a photodiode corresponding to the linear velocity determined by the controller and causes the photodiode to emit a laser light on the basis of a control signal corresponding to the determined read laser output; and
a sampling circuit which detects a laser light emitted by the photodiode and makes the control signal of the laser output determination circuit appropriate according to a sampling result obtained by performing the detection several times.

2. A disk device according to claim 1, wherein the laser output determination circuit determines the read laser output in proportion to a value of the linear velocity, and causes the photodiode to emit a laser light on the basis of a control signal corresponding to the determined read laser output.

3. A disk device according to claim 1, wherein, when a value of the linear velocity exceeds a predetermined threshold value, the laser output determination circuit changes the read laser output to a predetermined value previously prepared, and causes the photodiode to emit a laser light on the basis of a control signal corresponding to the determined read laser output.

4. A disk device according to claim 1, wherein the laser output determination circuit determines a read laser output of a photodiode according to the linear velocity in consideration of management information of the disk and operation information such as a user-desired recording velocity and the like.

5. A disk device according to claim 1, further comprising:
a processing section which performs reproducing processing and recording processing for the disk according to a laser light emitted in the laser output determination circuit.

6. A disk device comprising:
a controller which determines a linear velocity in order to rotate a disk at a constant angular velocity by CAV (Constant Angular Velocity) control on the basis of given operation information and control information read from the disk;
a laser output determination circuit which determines a read laser output of a photodiode according to the linear velocity determined by the controller in addition to the control information and the operation information, and causes the photodiode to emit a laser light on the basis of a control signal corresponding to the determined read laser output; and
a sampling circuit which detects a laser light emitted by the photodiode, and makes the control signal of the laser output determination circuit appropriate according to a sampling result obtained by performing the detection several times.

7. A disk device according to claim 6, wherein the laser output determination circuit determines the read laser output in proportion to a value of the linear velocity, and causes the photodiode to emit a laser light on the basis of a control signal corresponding to the determined read laser output.

8. A disk device according to claim 6, wherein, when a value of the linear velocity exceeds a predetermined threshold value, the laser output determination circuit changes the read laser output to a predetermined value previously prepared, and causes the photodiode to emit a laser light on the basis of a control signal corresponding to the determined read laser output.

9. A disk device according to claim 6, wherein the laser output determination circuit determines a read laser output of a photodiode according to the linear velocity in consideration of management information of the disk and operation information such as a user-desired recording velocity and the like.

10. A disk device according to claim 6, further comprising:
a processing section which performs reproducing processing and recording processing for the disk according to a laser light emitted by the laser output determination circuit.

11. A disk processing method comprising:
determining a linear velocity at the time of rotating a disk on the basis of given operation information and control information read from the disk;
determining a read laser output of a photodiode according to the determined linear velocity, and causing the photodiode to emit a laser light on the basis of a control signal corresponding to the determined read laser output; and
detecting a laser light emitted by the photodiode, and making the control signal of the laser output determination circuit appropriate according to a sampling result obtained by performing the detection several times.

12. A disk processing method according to claim 11, wherein the read laser output is determined in proportion to a value of the linear velocity to cause the photodiode to emit a laser light on the basis of a control signal corresponding to the determined read laser output.

13. A disk processing method according to claim 11, wherein, when a value of the linear velocity exceeds a predetermined threshold value, the read laser output is changed to a predetermined value previously prepared to cause the photodiode to emit a laser light on the basis of a control signal corresponding to the determined read laser output.

14. A disk processing method according to claim 11, wherein the determining a laser output determines a read laser output of a photodiode according to the linear velocity in consideration of management information of the disk and operation information such as a user-desired recording velocity and the like.

15. A disk processing method according to claim 11, further comprising:
performing reproducing processing and recording processing for the disk according to a laser light emitted by the laser output determination circuit.

16. A disk processing method comprising:
determining a linear velocity in order to rotate a disk at a constant angular velocity by CAV (Constant Angular Velocity) control on the basis of given operation information and control information read from the disk;
determining a read laser output of a photodiode according to the linear velocity determined by the controller, and causing the photodiode to emit a laser light on the basis of a control signal corresponding to the determined read laser output; and
detecting a laser light emitted by the photodiode by a monitor, and making the control signal of the laser output determination circuit appropriate according to a sampling result obtained by performing the detection several times.

17. A disk processing method according to claim 16, wherein the read laser output is determined in proportion to a value of the linear velocity to cause the photodiode to emit a laser light on the basis of a control signal corresponding to the determined read laser output.

18. A disk processing method according to claim 16, wherein, when a value of the linear velocity exceeds a predetermined threshold value, the read laser output is changed to a predetermined value previously prepared to cause the photodiode to emit a laser light on the basis of a control signal corresponding to the determined read laser output.

19. A disk processing method according to claim 16, wherein the determining a laser output determines a read laser output of a photodiode according to the linear velocity in consideration of management information of the disk and operation information such as a user-desired recording velocity and the like.

20. A disk processing method according to claim 16, further comprising:
performing reproducing processing and recording processing for the disk according to a laser light emitted by the laser output determination circuit.
